(19) United States
(12) Patent Application Publication
(10) Pub. No.: US 2003/0228112 A1
(43) Pub. Date: Dec. 11, 2003

(54) Solder mountable passive fiber optic components package

(76) Inventor: YouFu Shao, Milpitas, CA (US)

Correspondence Address: N. KENNETH BURRASTON, P.O. BOX 45898, 201 SOUTH MAIN STREET, SUITE 1800, SALT LAKE CITY, UT, 84145-0898, US

(21) Appl. No.: 10/170,606

(22) Filed: Jun. 11, 2002

(51) Int. Cl. G02B 6/42

(52) U.S. Cl. 385/88

(57) ABSTRACT

A solder mountable package assembly (1) for securing a passive fiber optic component (12) to a printed circuit board (PCB) according to the present invention includes a package (10), the fiber optic component, and a plurality of pins (11). The package includes a housing (102), a pair of caps (104) closing openings at the ends of the housing, and rubber boots 106 protecting optical fibers entering the housing. The pins are fixed to a bottom of the housing by soldering and the fiber optic component is assembled inside the housing and caps. The package assembly can be fixed to the PCB by inserting the pins through corresponding through holes in the PCB and soldering the pins to the through holes.

### BACKGROUND OF THE INVENTION

1. Field of the Invention

The present invention relates to fiber optic components packages, and particularly to a solder mountable package assembly for securing passive fiber optic components to a printed circuit board (PCB).

2. Related Art

Electro-optical devices are very commonly used in the modern fiber optics industry. Fiber optic components are often integrated with electronic circuits where a device having less volume is desired. Such devices include fiber optic components and electrical components on the same printed circuit board (PCB). Common examples include optical transceivers attached to a PCB, which have both electrical signal and fiber optic cable connectors. Sometimes, fiber optic passive components need to be integrated with electronic circuitry. There are two approaches to achieve this purpose. The first one is to combine a layer of fiber optic components with a layer of electronic circuitry, but this results in a large size package. The second way is to mount the fiber optic components on a PCB using screws or glue, with reference to FIG. 3. However, this requires extra space on the PCB for accommodating the screws, which is counter to the trend toward device miniaturization.

More importantly, soldering is often used when assembling electronic components to a PCB, while an additional procedure, possibly manual, is needed to assemble fiber optic passive components to the PCB using screws or glue, which is time-consuming and troublesome. This reduces productivity and increases cost. Also, neither of the above methods achieves the demands for compact size.

Accordingly, an improved package assembly for mounting passive fiber optic components to a PCB, and a method for making the same, is desired to overcome the above-mentioned problems.

### SUMMARY OF THE INVENTION

An object of the present invention is to provide a solder mountable package assembly for passive fiber optic components that is easily integrated with a printed circuit board (PCB).

Another object of the present invention is to provide a package assembly for fiber optic passive components which occupies little space on a PCB.

To achieve the above objects, a solder mountable package assembly for securing fiber optic passive components to a PCB, according to the present invention, includes a housing, a passive fiber optic component accommodated in the housing, and a plurality of pins extending from a bottom of the housing. The pins are soldered at one end to the housing and are soldered at the other end to the PCB. Since the pins extend downwardly from the bottom of the housing, the package assembly occupies approximately an area on the PCB of the housing bottom. Thus the design saves space. Moreover, since surface mounting technology (SMT) or another soldering technology is used to fix all the electronic elements and the fiber optic components to the PCB, no extra procedures using glue or screws, or other manual procedures, is required. The efficiency of assembling is improved.

These and additional objects, features and advantages of the present invention will become more apparent after reading the following detailed description of a preferred embodiment of the invention when taken in conjunction with the appended drawings, in which:

### BRIEF DESCRIPTION OF THE DRAWINGS

FIG. 1 is a perspective view of a solder mountable fiber optic components package according to the present invention;

FIG. 2 is a schematic view of the solder mountable fiber optic components package of FIG. 1 mounted to a printed circuit board (PCB); and

FIG. 3 is a perspective view of a fiber optic components package of the prior art.

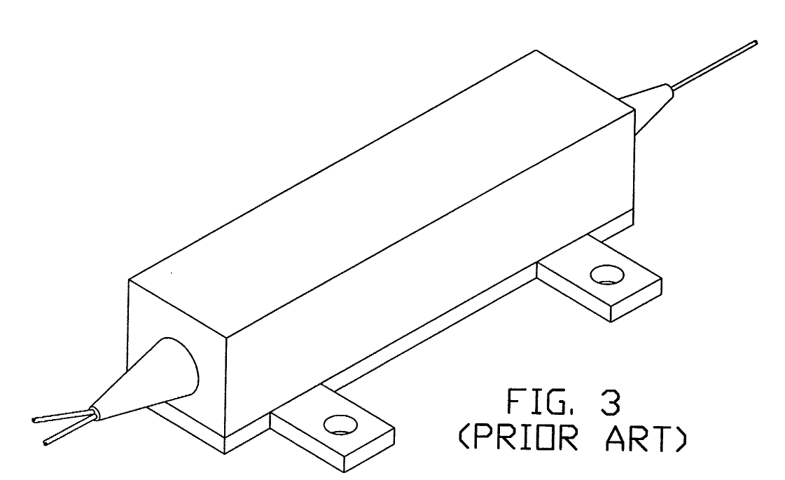

### DETAILED DESCRIPTION OF THE INVENTION

Those of ordinary skill in the art will realize that the following description of the present invention is illustrative only and not in any way limiting. Other embodiments of the invention will readily suggest themselves to such skilled persons having the benefit of this disclosure. Like reference numerals are used throughout to refer to like elements.

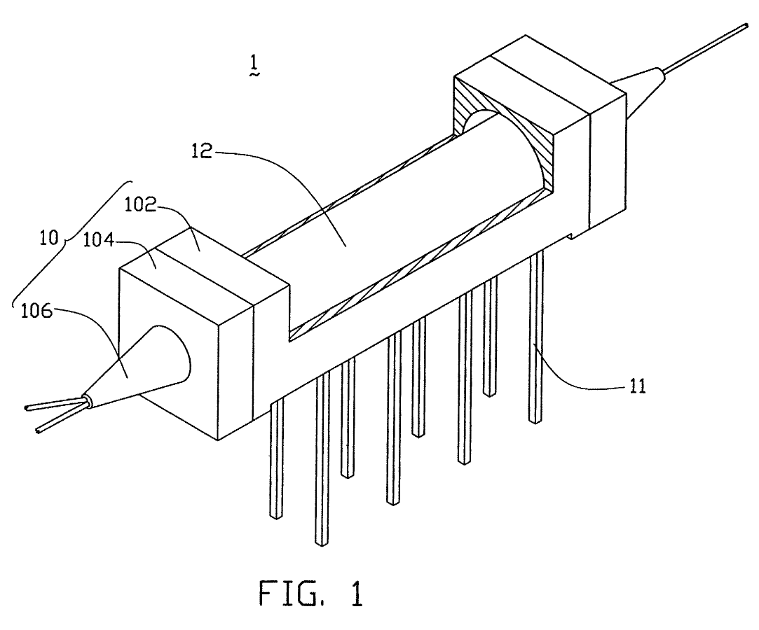

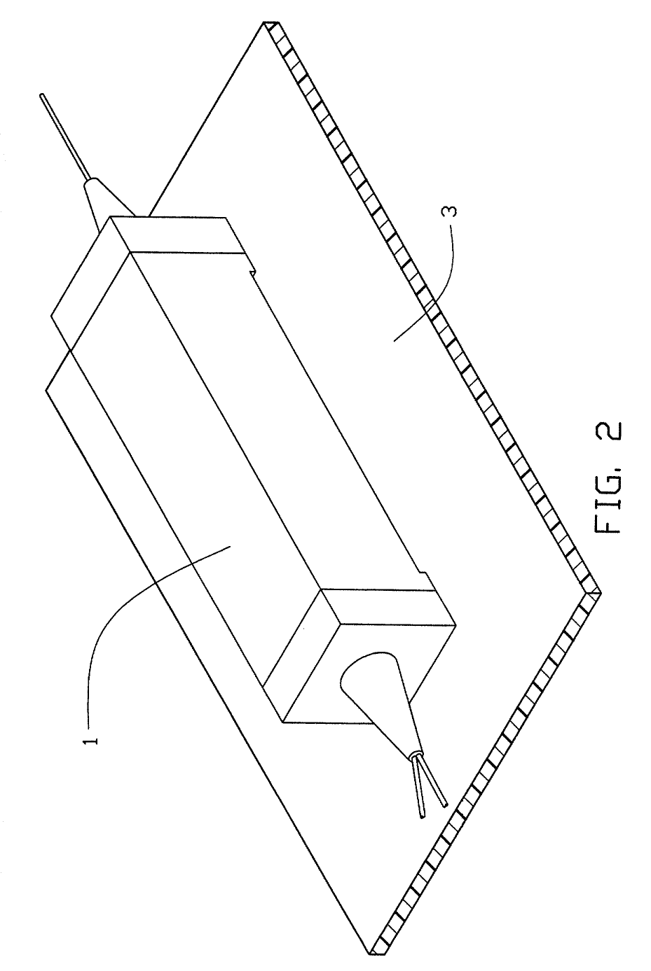

Turning now to FIG. 1 and FIG. 2, a solder mountable package assembly 1 for securing a passive fiber optic component 12 to a printed circuit board (PCB) 3 comprises a package 10, the passive fiber optic component 12 received in the package 10, and a plurality of pins 11 made of metal material. The passive fiber optic component 12 shown as an example in FIG. 1 is a wavelength divisional multiplexer (WDM), which has optical fibers (not labeled) located therein. The package 10 comprises a housing 102 made of metal for accommodating the fiber optic component 12 therein, two caps 104, and a pair of rubber boots 106 used to protect the optical fibers entering the housing 102. The housing 102 has two openings at opposite ends for passage of the fiber optic component 12 during assembly and for passage of the optical fibers when assembled. The caps 104 are used to cover the openings to encapsulate the fiber optic component 12 completely. The pins 11 extend downwardly from a bottom (not labeled) of the housing 102, and can be attached to the housing 12 using point soldering or other well-known techniques. The housing 102 can alternatively be made of a plastic material.

A process of assembling the package assembly 1 includes the followings steps: (1) providing the housing 102 having two openings at opposite ends; (2) attaching a plurality of pins 11 to the bottom of the housing 102 by point soldering; (3) inserting the passive fiber optic component 12 through one of the two openings into the housing 102; (4) covering the openings with corresponding caps 104 and fixing boots 106 to the caps 104 to encapsulate the fiber optic component 12 completely; and (5) inserting the pins 11 through through holes (not shown) in the PCB 3 and soldering the pins 11 to the through holes in the PCB 3. Since the pins extend downwardly from the bottom of the housing 102, the package assembly 1 takes up only the space on the PCB 3 of an area of the bottom of the housing 102 and a bottom surface of the two caps 104, saving space on the PCB 3. Thus, this design saves space on the PCB 3 and promotes miniaturization of components on a PCB. Moreover, since surface mounting technology (SMT) or another soldering technology is used to fix all the electronic elements and the fiber optic components to the PCB 3, no extra procedures using glue or screws, or other manual procedures, is required to assemble such fiber optic components on the PCB 3. The efficiency of assembling is thereby greatly improved.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

I claim:

1. A package assembly for securing a passive optical component to a printed circuit board (PCB) using a soldering technique, comprising:
a package comprising a housing adapted to accommodate the passive optical component; and
a plurality of pins extending from a bottom of the housing, one end of each pin being fixed to the bottom by soldering; and the package being fixed on the PCB by the other end by soldering.

2. The package assembly of claim 1, wherein the housing has two openings at opposite ends.

3. The package assembly of claim 2, wherein the package has two caps for covering the openings.

4. The package assembly of claim 3, wherein the package has a pair of elastic elements protecting optical fibers connecting to the passive optical component.

5. The package assembly of claim 2, wherein the housing is a rectangular shell.

6. The package assembly of claim 2, wherein the housing is made of metal material.

7. The package assembly of claim 2, wherein the housing is made of plastic material.

8. A method of assembling a mountable package assembly for securing a passive optical component to a PCB using a soldering technique, comprising the followings steps of:
(1) providing a housing having two openings at opposite ends;
(2) attaching a plurality of pins to a bottom of the housing by point soldering;
(3) inserting a passive fiber optic component through one of the two openings into the housing;
(4) covering the openings with corresponding caps and fixing boots to the caps to encapsulate the fiber optic component completely; and
(5) inserting the pins through through holes in the PCB and soldering the pins to the through holes in the PCB.

9. The method of claim 8, wherein the pins are attached to a bottom of the housing by way of point soldering before the housing is soldered to the PCB.

10. The method of claim 8, wherein the housing has two openings at opposite ends.

11. The method of claim 8, wherein the passive component is inserted into the housing through one of the openings.

12. The method of claim 8, wherein the caps cover the openings to encapsulate the housing.

13. A package assembly comprising:
a package including an insulative housing enclosing an fiber optic component with fibers extending out two opposite ends of the housing;
a plurality of metallic soldering pins extending from a bottom face of the housing away from said housing; and
a printed circuit board positioned under said housing and including means cooperating with said soldering pins for soldering said pins thereto so as to secure the package thereto.
